(19) United States
(12) Patent Application Publication
(10) Pub. No.: US 2016/0110609 A1
(43) Pub. Date: Apr. 21, 2016

(54) METHOD FOR OBTAINING A MEGA-FRAME IMAGE FINGERPRINT FOR IMAGE FINGERPRINT BASED CONTENT IDENTIFICATION, METHOD FOR IDENTIFYING A VIDEO SEQUENCE, AND CORRESPONDING DEVICE

(71) Applicant: THOMSON LICENSING, Issy les Moulineaux (FR)

(72) Inventors: Frederic Lefebvre, Rennes (FR); Joaquin Zepeda Salvatierra, St. Jacques-De-La-Lande (FR); Patrick Perez, Rennes (FR)

(21) Appl. No.: 14/786,983

(22) PCT Filed: Apr. 25, 2014
(86) PCT No.: PCT/EP2014/058419

§ 371 Date: Oct. 25, 2015

(30) Foreign Application Priority Data
Apr. 25, 2013 (EP) 13305545.9

(51) Int. Cl. G06K 9/00; G06K 9/62

(52) U.S. Cl. CPC G06K 9/00744; G06K 9/6202

(57) ABSTRACT

A temporal section that is defined by boundary images is selected in a video sequence. A maximum of k stable image frames are selected in the temporal section of image frames having a lowest temporal activity. Image fingerprints are computed from the selected stable image frames. A mega-frame image fingerprint data structure is constructed from the computed fingerprints.

### 1. FIELD

The field the present disclosure relates to a method, device and system for selection of image frames for fingerprint based content identification.

### 2. TECHNICAL BACKGROUND

The technical background of the present disclosure is related to matching of extracts of a video sequence to extracts of video sequences in a database through video frame “fingerprint” comparison. Extracting a fingerprint in this context, means extracting characterizing features, enabling a video or a particular sequence in the video to be identified, for use in various applications, for example: DRM for Digital Rights Management, SmartTV for providing enhanced features for a user when watching TV, that are related to the content watched, tracking of illegal content, etc.

From a video sequence, video frame fingerprints (such as generated by RASH (RAdial haSH function), SIFT (Scale Invariant Feature Transform), SURF (Speeded Up Robust Features) digest vectors are extracted and these are compared to a database comprising video frame fingerprints. The database is filled with fingerprints from previously processed video sequences. A prior art method for selection of video frames to extract from a video sequence for fingerprinting is for example through regular sampling; a sample is extracted every n video frames. However, this process creates a lot of data, and as the frames are selected without further knowledge, they are often not optimal for fingerprint generation and comparing. A prior art improvement consists therefore of recognizing so-called “key frames” in the video sequence, such as shot boundary frames and shot stable frames, and only compare the digest vectors of these key frames of a video. Shot boundaries correspond to brutal variations of visual content of a video, e.g. a scene cut. Shot stable frames correspond to a frame within a shot with low temporal activity (i.e. frames that comprise relatively few differences with surrounding frames). Both shot boundary frames and shot stable frames can be localized by analyzing the distance between digest vectors of successive video frames. A shot boundary is detected when this distance exceeds a threshold. A shot stable frame is located by determining where in a shot the digest vectors vary the least. Once the fingerprints of the selected key frames are computed, they are transmitted to a server for comparison with fingerprints in the database.

If fingerprint generation methods do not take into account the context of the fingerprints generated (i.e. the shot boundaries) and fingerprints are transmitted independently, precious information such as fingerprint context is lost. Also, within a shot boundary, a single selected key frame might not give enough material to do a good search. Also, when key frames are selected from encoded content (such as MPEG-2, H.264, etc) on these prior art selection criteria, the selected frames might not be of the best quality for obtaining a meaningful fingerprint given the encoding used. Fingerprint generation techniques can thus be further optimized in order to further increase the probability of identification of a video sequence.

### 3. SUMMARY

The present disclosure comprises embodiments that aim at alleviating some of the inconveniences of prior art.

Therefore, the present disclosure comprises a method of obtaining a mega-frame image fingerprint from a temporal section of a video sequence for fingerprint based identification of a video sequence, comprising: determining of a temporal section defined by boundary image frames in the video sequence, the boundary image frames delimiting a sequence of image frames in the video sequence; determining of a predetermined maximum of k stable image frames j in the determined temporal section, by computing of a sum of similarity distances between a predetermined number of neighbor image frames of a candidate stable image frame j in the determined temporal section and determining the k minimum computed sums of similarity distances in the temporal section, while respecting a predetermined interspacing of at least n image frames between the stable image frames j; for each of the determined maximum k stable image frames j, computing an image fingerprint, and constituting of a mega-frame image fingerprint data structure that is a union of the computed image fingerprints; and storing of the mega-frame image fingerprint data structure in a data base.

According to a variant embodiment of the method of obtaining mega-frame image fingerprints, the boundary image frames are detected by analyzing a distance between digest vectors computed over successive image frames of the video sequence, a boundary image frame being detected when the distance between the digest vectors exceeds a predetermined threshold.

According to a further variant embodiment of the method, the method comprises, after determining of a predetermined maximum of k stable image frames j and before computing of image fingerprints for the image frames j, for each of the maximum k determined stable image frames j, a further step of determining an I-frame within a selection window of a predetermined width of M frames, the selection window being centered in the determined stable image frame j, the determined I-frame replacing the determined stable image frame j.

According to a further variant embodiment of the method, the method comprises, after determining of a predetermined maximum of k stable candidate image frames j and before computing of image fingerprints from the image frames j, for each of the maximum k determined stable candidate image frames j, a further step of determining of a luminuous image frame, of which a luminous exposure is within predetermined limits, within a selection window of a predetermined width of M frames, the selection window being centered in the determined stable candidate image frame j, the determined luminous image frame replacing the determined stable image frame j.

According to a further variant embodiment of the method, the method comprises enhancing the data structure with metadata comprising information related to a temporal position of the fingerprints in the data structure with regard to the video sequence.

According to a further variant embodiment of the method, the data structure is stored as an aggregated set of image fingerprints.

The present disclosure also concerns a method of identifying a video sequence, comprising steps of determining a temporal section of the video sequence defined by boundary image frames in the video sequence, the boundary image frames delimiting a sequence of image frames in the video sequence; determining a predetermined maximum of k stable image frames in the determined temporal section, by computing of a sum of similarity distances between a predetermined number of neighbor image frames of a candidate stable image frame j in the determined temporal section and determining the k minimum computed sums of similarity distances in the temporal section, while respecting a predetermined interspacing of at least n image frames between the stable image frames; for each of the determined maximum k stable image frames j, computing an image fingerprint, and constituting of a mega-frame image fingerprint data structure that is a union of the computed image fingerprints; comparing the constituted mega-frame image fingerprint data structure with mega-frame image fingerprint data structures from an image fingerprint data base; and the video sequence being identified by one of the data structures in the data base, if upon the comparing a data structure is found in the data base that corresponds to the constituted data structure.

According to a variant embodiment of the method of identifying a video sequence, the comparing is done according to a Nearest Neighbor Search method.

According to a variant embodiment of the method of identifying a video sequence, the comparing is done according to a Locality Sensitive Hashing search method.

According to a variant embodiment of the method of identifying a video sequence, the comparing is done according to a Product Quantization search method.

The present disclosure also comprises a device for obtaining a mega-frame image fingerprint from a temporal section of a video sequence, the device comprising: a temporal section determinator for determining a temporal section of the video sequence, the temporal section being defined by boundary image frames in the video sequence, the boundary image frames delimiting a sequence of image frames; a stable frame determinator for determining a predetermined maximum of k stable image frames j in the determined temporal section, by computing of a sum of similarity distances between a predetermined number of neighbor image frames of a candidate stable image frame j in the determined temporal section and determining the k minimum computed sums of similarity distances in the temporal section, while respecting a predetermined interspacing of at least n image frames between the stable image frames j; a data structure constructor, for computing of an image fingerprint for each of the determined maximum k stable image frames j, and for constituting a mega-frame image fingerprint data structure that is a union of the computed image fingerprints; and a memory for storing of the constituted mega frame image fingerprint data structure.

The present disclosure also relates to a device for identifying a video sequence, the device comprising: a temporal section determinator for determining a temporal section of the video sequence defined by boundary image frames in the video sequence, the boundary image frames delimiting a sequence of image frames in the video sequence; a stable frame determinator for determining a predetermined maximum of k stable image frames in the determined temporal section, by computing of a sum of similarity distances between a predetermined number of neighbor image frames of a candidate stable image frame j in the determined temporal section and determining the k minimum computed sums of similarity distances in the temporal section, while respecting a predetermined interspacing of at least n image frames between the stable image frames; a data structure constructor for computing of an image fingerprint for each of the determined maximum k stable image frames j, and for constituting of a mega-frame image fingerprint data structure that is a union of the computed image fingerprints; a data structure comparator for comparing the constituted mega-frame image fingerprint data structure with mega-frame image fingerprint data structures from an image fingerprint data base; and the video sequence being identified by one of the data structures in the data base, if upon the comparing a data structure is found in the data base that corresponds to the constituted data structure.

### 4. LIST OF FIGURES

More advantages of the present disclosure will appear through the description of particular, non-restricting embodiments.

The embodiments will be described with reference to the following figures:

FIG. 1 is a flow chart showing a method of fingerprint registration according to a non-limited particular embodiment.

FIG. 2 is a flow chart showing a process of fingerprint matching according to a non-limited particular embodiment.

FIG. 3 is a diagram that shows extraction of information from a video sequence according to a non-limited particular embodiment.

FIG. 4 is a non-limiting embodiment of a device 400 that can be used for implementing the method of selecting image frames for fingerprint based identification of a video sequence.

FIG. 5 is a non-limiting embodiment of a device 500 that can be used for implementing the method of identifying a video sequence.

### 5. DETAILED DESCRIPTION

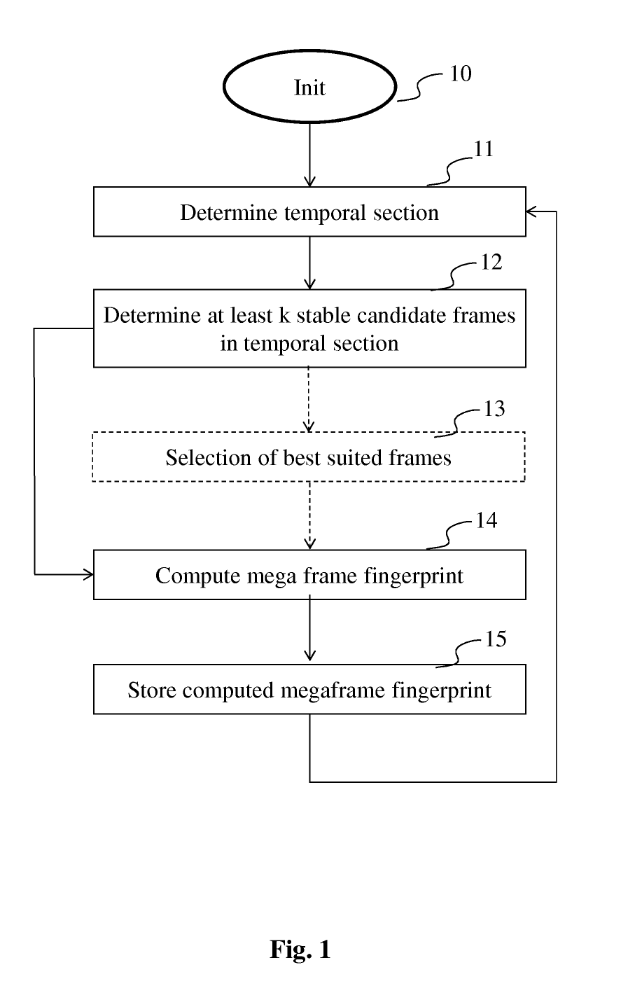

FIG. 1 is a flow chart showing a process of fingerprint registration of a video sequence according to a particular, non limiting embodiment.

In a first step 10, variables and parameters are initialized that are used for execution of the method.

In a step 11, a temporal section of the video sequence is determined.

This determination is based on analysis of difference between adjacent image frame descriptors, which are computed with a digest vector computing algorithm such as RASH. Boundary image frames are detected when the distance between digest vectors exceeds a predetermined threshold. This step thus allows to determine the image frames that present shot boundaries (or scene change), and thereby delimits a temporal section of the video sequence.

In a step 12, a predetermined maximum of k stable candidate image frames are determined within the temporal section determined in step 11. The value of k depends on multiple factors, such as the length of the temporal section, temporal activity of the images in the temporal section. The determination of stable candidate image frames is based on computing of a similarity distance (such as Euclidian distance) between the image frames inside the temporal section, which allows finding image frames where the temporal activity is the lowest (i.e. low temporal activity frames are frames that comprise relatively few differences with surrounding frames): i.e. the sum of similarity distances in a sliding window (i.e. sliding between the beginning and the end of the temporal section) of a width of M frames, centered in a frame j, is among the minimum sums of similarity distance values attained in the temporal section; the frame j is called a stable frame. The value of M is a tradeoff between robustness and frame accuracy. As an example, a value of M=5 has proven to be a good tradeoff. A predetermined maximum of k stable frames are thus selected from the temporal section, whereby the interspacing between the selected frames is at least a predetermined number of n frames. The parameters k and n will drive the density and number of candidate frames in the temporal section. Example values for k and n are k=5 or 10, n=10 or 20. The formula hereunder gives an example for computing the k stable frames:

$$kStableFrame = \{ l \vert ( Dist ( l ) = {k min}_{i ∈ Shot} ( \{ Dist ( i ) \} ) ) \}$$

$$Dist ( i ) = \frac{1}{2 M + 1} {\sum }_{{j = i - M}_{{j ∈ Shot}_{j \neq i}}}^{i + M} {‖ RASH ( i ) - RASH ( j ) ‖}_{2}$$

$$\vert kStableFrame \vert < k$$

In an optional step 13 (depicted with broken lines), for each of the previous determined maximum k stable candidate frames j selected in step 12 in the determined temporal section selected in step 11, a best suited frame is determined within a selection window surrounding the determined stable frame for a generation of an image fingerprint, for example a best suited image frame is an I-type encoded frame (or “I-frame”) because these frames exhibit less compression artifacts. The “I” of “I-frame” stands for Intra-coded frames meaning that their decoding does not depend on other frames, such as is the case for B or P type frames. The I-frames thus comprise complete information on a given image frame, whereas the B or P frames comprise incomplete information on the image frame to which they relate. Other “best suited” frames are for example frames with a luminosity exposure that is within predetermined limits, thereby avoiding the selection of difficult to exploit over- or under exposed images. Both variants can be combined to form a particular advantageous variant embodiment, wherein best suited frames are I-frames that have a luminosity exposure within the predetermined limits.

In a step 14, a so-called mega frame image fingerprint is constituted, that comprises the union of fingerprints of the maximum k image frames determined in step 12 or optionally in step 13 that are within the boundaries of the temporal section determined in step 11.

According to a variant embodiment, the mega-frame image fingerprint data structure is stored as a set of associated fingerprints {FP1, FP2, FPn}, each fingerprint of the set being stored. According to a further variant embodiment, the union is stored in a compressed, aggregated format such as VLAD (Vector Locally Aggregated Descriptor), BOF (Bag Of Features), or Fisher, so as to create a more compact descriptor that takes less storage space, which is advantageous for reasons of scalability.

In a step 15, the mega frame image fingerprint data structure constituted in step 14 is stored in a memory (e.g. in a data base) for further reference, e.g. for identification of video sequences.

The method is repeated by returning to step 11, for processing of a next temporal section. This is possibly repeated for all temporal sections that can be determined in the video sequence. When all temporal sections have been handled, the data base contains a set of mega-frame image fingerprint data structures that characterize the video sequence, and which can be used for example by a method allowing to identify a given video sequence among a plurality of video sequences.

As mentioned, according to a variant embodiment, a selection of best-suited image frames (e.g. I-frames) is done preferably by adding a constraint for the selection of image frames in steps 12 and 13, so as to avoid selection of overexposed (very bright) or underexposed (very dark) image frames. According to this embodiment, the determining of the best suited image frames comprises a selection of the best suited image frames according to their luminous exposure being within predetermined limits for under- and overexposure. Luminous exposure is accumulated quantity of visible light energy, weighted by a luminosity function. Such a selection is done for example by analysis of the entropy of the computed digest vector. If the digest vector is not within predefined bounds, another neighboring candidate image frame is searched for.

The above described fingerprint registration method can be executed as an ‘off line’ process, that processes a whole or a fragment of a movie for example and fills a database with the mega frame image fingerprint obtained. The data structure can be enhanced with metadata comprising additional information such as temporal information allowing a mega frame image fingerprint to be related to temporal position (e.g. in terms of hours, minutes, seconds, milliseconds from movie start) of the fingerprints in the data structure with regard to the video sequence, and/or with information obtained from other sources such as movie identification, scene identification, actors, producer, etc. The additional information can be used in the fingerprint matching process such as a method of identifying a video sequence.

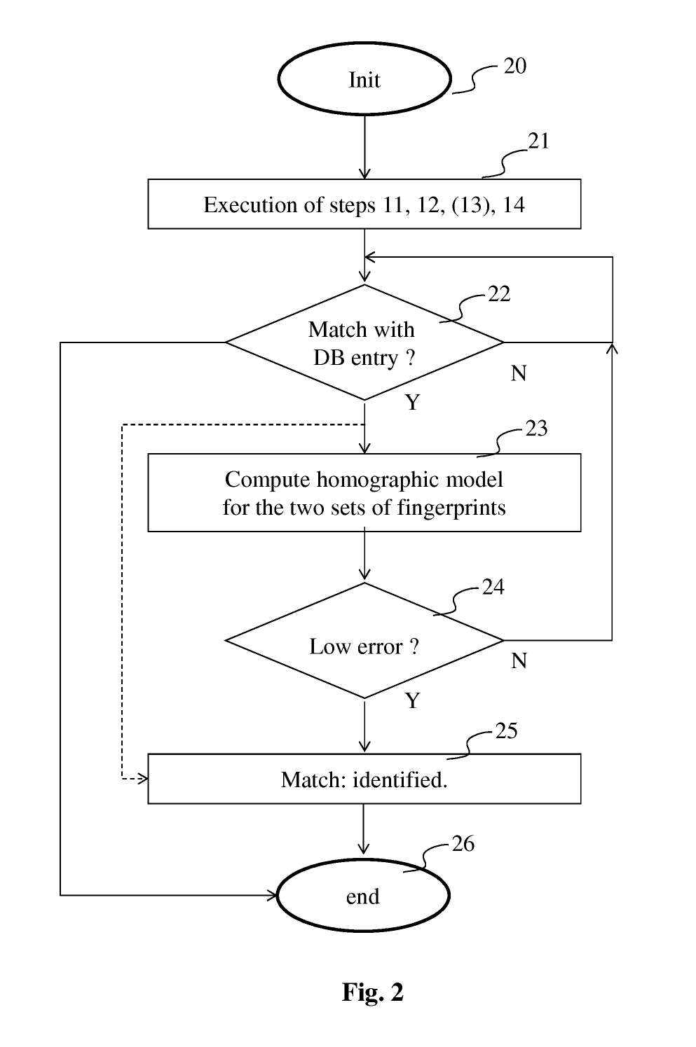

FIG. 2 is a flow chart showing a process of fingerprint matching or identification of a video sequence according to a particular, non limiting embodiment.

In a first step 20, variables and parameters are initialized that are used for execution of the method.

In a second step 21, the steps 11-14 of FIG. 1 are executed on a part of a video sequence that is to be identified. This results in a computed mega frame image fingerprint, obtained from the video sequence that is to be identified.

In a third step 22, it is verified if a match can be made between the mega frame image fingerprint computed in step 21 and any of the mega frame image fingerprints stored in the database that was constructed with the previously discussed method discussed with regard to FIG. 1. Such verification is done by comparing the computed mega frame image fingerprint and the mega frame image fingerprints in the database. If a candidate mega frame image fingerprint is found that matches, step 23 is executed. If not, another matching mega frame image fingerprint is searched for in the database. Step 22 is repeated until there are no more matching candidate mega frame image fingerprints discovered in the database, which results in going to step 26 (end). The matching is done as follows. If the computed mega frame image fingerprint data structure is a set of individual fingerprints (e.g. {FP1, FP2, FPn} as previously discussed), each of the fingerprints FP, FP, FPn of the computed mega-frame image fingerprint data structure are individually compared to the individual fingerprints in the data base. If the computed mega-frame image fingerprint data structure is a previously discussed aggregated set of image fingerprints (e.g. VLAD), the comparison between the computed mega-frame image fingerprint data structure and those in the database is done directly using the aggregated set of fingerprints, i.e. directly comparing the data structures without the previous described individual comparison. Comparing of individual fingerprints or of aggregated fingerprints can be done using an exhaustive search method (all data base entries are compared) or according to a variant embodiment, using a faster but less precise search method such as ANN or NNS (Approximate Nearest Neighbor or Nearest Neighbor Search), LSH (Locality-Sensitive Hashing), or PQ code (Product Quantization). If a search on individual fingerprints is done, each of the individual image fingerprints of the computed mega frame image fingerprint data structure is compared to the individual image fingerprints stored in the data base. The couple (fingerprint from mega frame, fingerprint from data base) that obtains the highest score of matches, is considered as being the image frame that identifies one of the image frames in the mega frame fingerprint, i.e. it is a matching candidate fingerprint.

In step 23, a matching candidate mega frame fingerprint is found in the database, and a homographic model is computed over the two sets of fingerprints (the computed mega frame fingerprint obtained in step 21, and the candidate mega frame fingerprint found in the data base in step 22). Homographic model computation (or Affine model) is known by the skilled in the art as being used for extracting parametric model (rotation, scaling, shift, . . . ) of distortions between a candidate frame and a reference frame.

In a step 24, the errors resulting of the homographic model computation done in step 23 are compared with a threshold. This threshold is defined as, for example, a number of average pixel errors after reconstruction, a number of outliers. If the number of errors is lower than the threshold, it is considered that the video sequence is identified by the matching in the data base of the mega frame fingerprint computed in step 21 and the mega frame fingerprint fetched from the data base in step 22, and the method ends with step 26.

If the mega fingerprint is stored as previously discussed aggregated set of fingerprints (e.g. VLAD), steps 23 and 24 are omitted. This case is illustrated by a dashed arrow routing the ‘Y’ exit of step 22 directly to step 25.

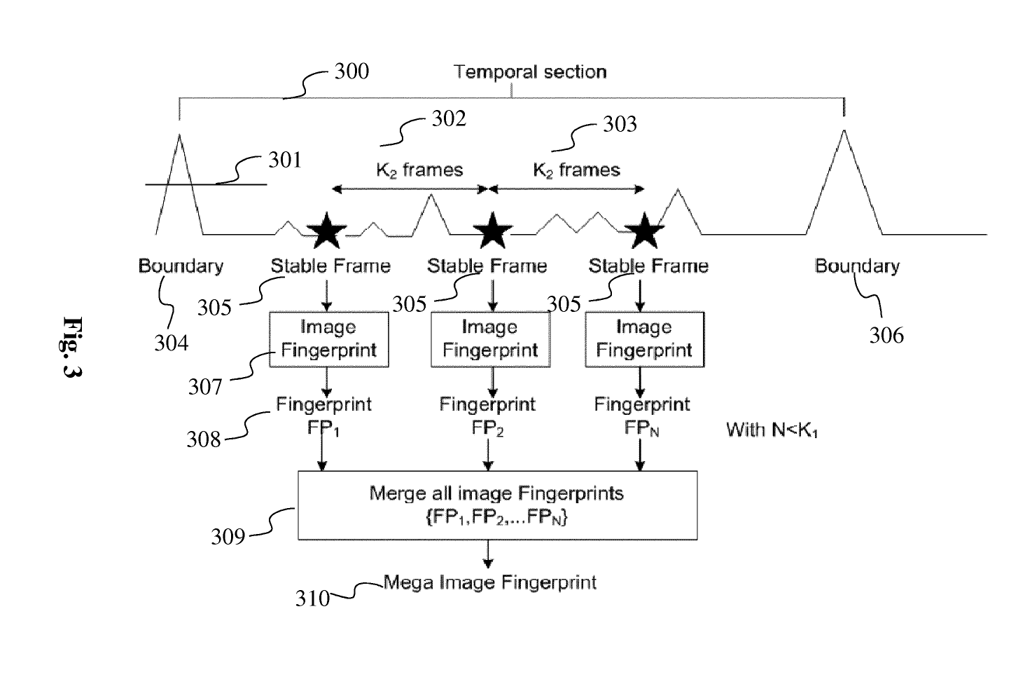

FIG. 3 is a diagram that shows a particular non-limiting embodiment of extraction of information from a video sequence. Element 300 defines a temporal section that is delimits a certain number of image frames in the video sequence. Elements 304 and 306 are boundary frames, that have a computed digest vector of which the distance with surrounding frames exceeds a threshold 301. Elements 305 represent stable frames. Elements 302 and 303 illustrate how stable frames that are found within the temporal section are interspaced by at least n frames. Element 307 illustrates the process of computing a fingerprint from each stable frame, resulting of storing (308, 309) each computed fingerprint in a mega image fingerprint 310 that comprises fingerprints FP1, FP2, to FPn.

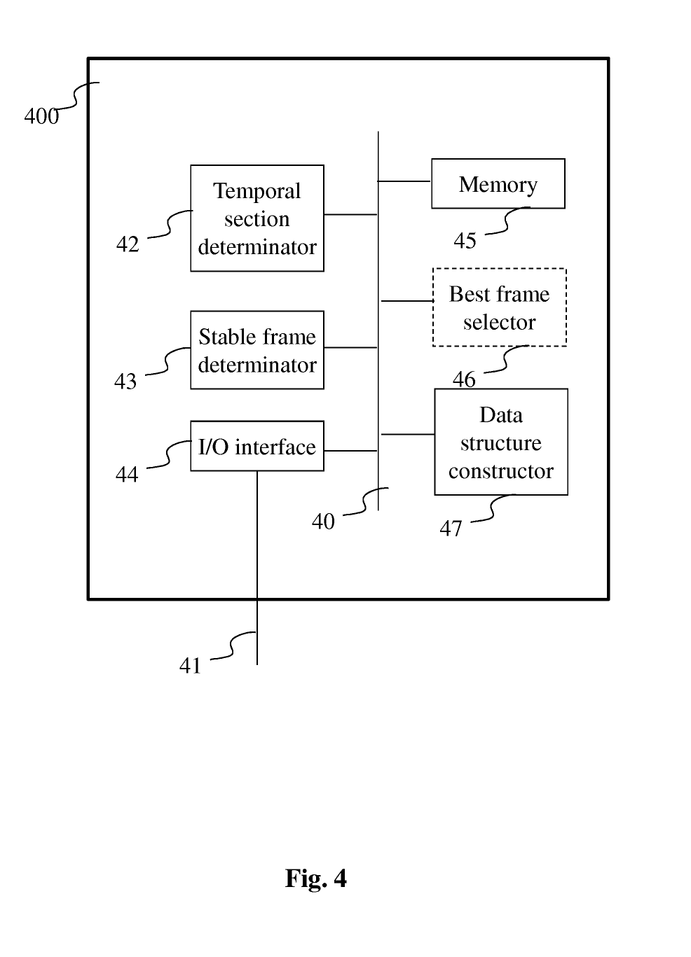

FIG. 4 is a non-limiting embodiment of a device 400 that can be used for implementing the method of selecting image frames for fingerprint based identification of a video sequence. The device comprises the following components, interconnected by a digital data- and address bus 40:
a temporal section determinator 42;
a stable frame determinator 43;
a memory 45;
a network interface 44, for interconnection of device 400 to other devices connected in a network via connection 41, such as to a database server;
a best frame selector 46 (optional); and
a mega-frame image fingerprint data structure constructor 47.

Modules 42, 43, 46 and 47 can be implemented as a microprocessor, a custom chip, a dedicated (micro-) controller, and so on. Memory 55 can be implemented in any form of volatile and/or non-volatile memory, such as a RAM (Random Access Memory), hard disk drive, non-volatile random-access memory, EPROM (Erasable Programmable ROM), and so on. Device 400 is suited for implementing the method of obtaining a mega-frame image fingerprint from a temporal section of a video sequence, which mega-frame can be used for fingerprint based identification of a video sequence. The device comprises:

a temporal section determinator 42 for determining a temporal section of the video sequence, the temporal section being defined by boundary image frames in the video sequence, the boundary image frames delimiting a sequence of image frames.

a stable frame determinator 43 for determining a predetermined maximum of k stable candidate image frames j in the determined temporal section, by computing of a sum of similarity distances between a predetermined number of neighbor image frames of a candidate stable image frame j in the determined temporal section and determining the k minimum computed sums of similarity distances in the temporal section, while respecting a predetermined interspacing of at least n image frames between the stable image frames j.

an optional best frame selector 46 for determining, for each of the maximum k determined stable candidate image frames j, image frames that are for example I-frames or frames with a luminosity exposure within predetermined limits, or both, within a selection window of a predetermined width of M image frames, the selection window being centered in the determined stable candidate image frame j.

a data structure constructor 47, that, for each of the maximum k determined image frames, computes an image fingerprint, and that constitutes a mega-frame image fingerprint data structure that is a union of the maximum k computed image fingerprints.

a memory 45 for storing of the constituted megaframe image fingerprint data structure.

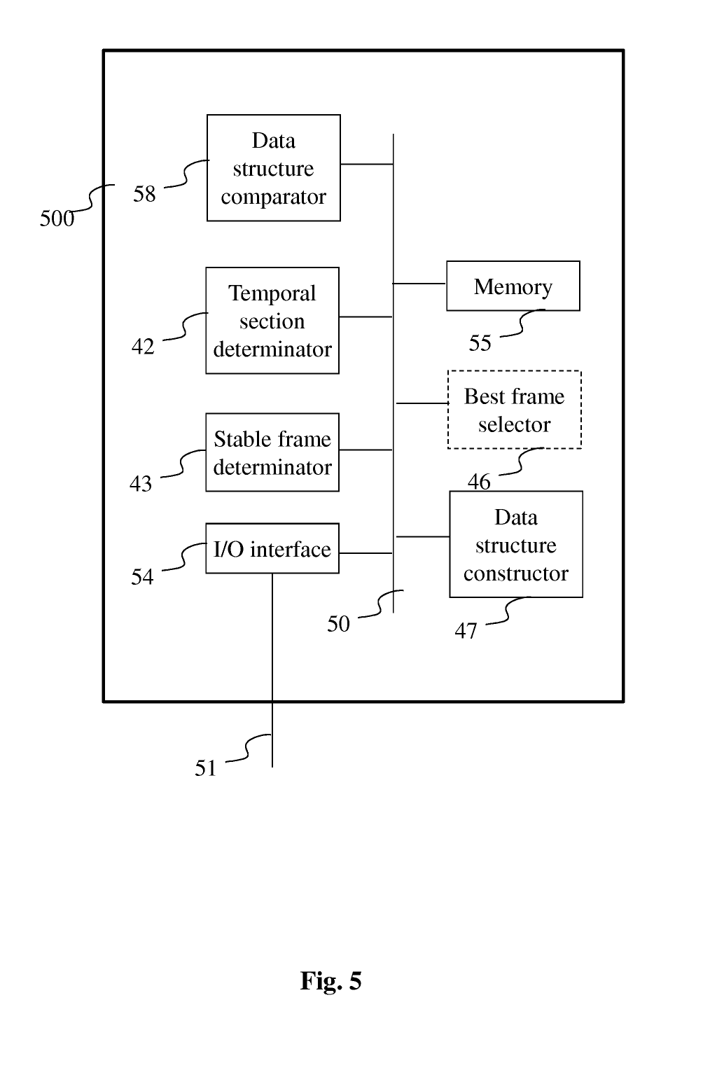

FIG. 5 is a non-limiting embodiment of a device 500 that can be used for implementing the method of identifying a video sequence. The device comprises the following components, interconnected by a digital data- and address bus 50:
A temporal section determinator 42;
A stable frame determinator 43;
a memory 55;
a network interface 54, for interconnection of device 500 to other devices connected in a network via connection 51, such as to a database server;
an best frame selector 46 (optional);
a data structure constructor 47; and
a data structure comparator 58.

Modules 42, 43, 46, 47 and 58 can be implemented as a microprocessor, a custom chip, a dedicated (micro-) controller, and so on. Memory 45 can be implemented in any form of volatile and/or non-volatile memory, such as a RAM (Random Access Memory), hard disk drive, non-volatile random-access memory, EPROM (Erasable Programmable ROM), and so on. Device 400 is suited for implementing the method of identification of a video sequence. The elements 42, 43, 46 and 47 of device 500 are similar to those of device 400, and their function is not described further here. The data structure comparator compares the data structure built by module 47 with data structures of in a data base (e.g., the data base in which device 400 stores its data structures), and the video sequence is identified by one of said data structures in the data base if upon the comparing a matching data structure is found in the data base.

As will be appreciated by those skilled in the art, aspects of the present principles can be embodied as a system, method or computer readable medium. Accordingly, aspects of the present principles can take the form of an entirely hardware embodiment, en entirely software embodiment (including firmware, resident software, micro-code and so forth), or an embodiment combining hardware and software aspects that can all generally be defined to herein as a “circuit”, “module” or “system”. Furthermore, aspects of the present principles can take the form of a computer readable storage medium. Any combination of one or more computer readable storage medium(s) can be utilized.

Thus, for example, it will be appreciated by those skilled in the art that the block diagrams presented herein represent conceptual views of illustrative system components and/or circuitry embodying the present principles. Similarly, it will be appreciated that any flow charts, flow diagrams, state transition diagrams, pseudo code, and the like represent various processes which may be substantially represented in computer readable storage media and so executed by a computer or processor, whether or not such computer or processor is explicitly shown.

A computer readable storage medium can take the form of a computer readable program product embodied in one or more computer readable medium(s) and having computer readable program code embodied thereon that is executable by a computer. A computer readable storage medium as used herein is considered a non-transitory storage medium given the inherent capability to store the information therein as well as the inherent capability to provide retrieval of the information there from. A computer readable storage medium can be, for example, but is not limited to, an electronic, magnetic, optical, electromagnetic, infrared, or semiconductor system, apparatus, or device, or any suitable combination of the foregoing. It is to be appreciated that the following, while providing more specific examples of computer readable storage mediums to which the present principles can be applied, is merely an illustrative and not exhaustive listing as is readily appreciated by one of ordinary skill in the art: a portable computer diskette; a hard disk; a read-only memory (ROM); an erasable programmable read-only memory (EPROM or Flash memory); a portable compact disc read-only memory (CD-ROM); an optical storage device; a magnetic storage device; or any suitable combination of the foregoing.

1-12. (canceled)

13. A method for obtaining a mega-frame image fingerprint from a temporal section of a video sequence for fingerprint based identification of a video sequence, comprising:
selecting a temporal section defined by boundary image frames in the video sequence, said boundary image frames delimiting a sequence of image frames in the video sequence;
selecting a maximum of k stable image frames j in the selected temporal section, by computing a sum of similarity distances between a number of neighbor image frames of a candidate stable image frame j in the selected temporal section and determining the k minimum computed sums of similarity distances in the temporal section, while respecting an interspacing of at least n image frames between the stable image frames j;
for each of the selected maximum k stable image frames j, selecting an image frame within a selection window of a width of M frames, the selection window being centered in the selected stable image frame j, the selected image frame replacing the selected stable image frame j; and
for each of the selected maximum k stable image frames j, computing an image fingerprint, and constructing a mega-frame image fingerprint data structure that comprises the computed image fingerprints.

14. The method according to claim 13, wherein said boundary image frames are detected by analyzing a distance between digest vectors computed over successive image frames of said video sequence, a boundary image frame being detected when said distance between said digest vectors exceeds a threshold.

15. The method according to claim 13, wherein said image frame selected in said step of selecting an image frame within a selection window is an I-frame.

16. The method according to claim 13, wherein said image frame selected in said step of selecting an image frame within a selection window is an image frame of which a luminous exposure is within defined limits.

17. The method according to claim 13, further comprising enhancing said data structure with metadata comprising information related to a temporal position of the fingerprints in the data structure with regard to the video sequence.

18. The method according to claim 13, wherein said data structure is stored as an aggregated set of image fingerprints.

19. A method for identifying a video sequence, wherein it comprises:
selecting a temporal section of the video sequence defined by boundary image frames in the video sequence, said boundary image frames delimiting a sequence of image frames in the video sequence;
selecting a maximum of k stable image frames in the selected temporal section, by computing of a sum of similarity distances between a number of neighbor image frames of a candidate stable image frame j in the selected temporal section and determining the k minimum computed sums of similarity distances in the temporal section, while respecting an interspacing of at least n image frames between the stable image frames;
for each of the selected maximum k stable image frames j, computing an image fingerprint, and constructing a mega-frame image fingerprint data structure that comprises the computed image fingerprints;
for each of the selected maximum k stable image frames j, selecting an image frame within a selection window of a width of M frames, the selection window being centered in the selected stable image frame j, the selected image frame replacing the selected stable image frame j;
comparing the constructed mega-frame image fingerprint data structure with mega-frame image fingerprint data structures from an image fingerprint data base; and
said video sequence being identified by one of said data structures in said data base, if upon said comparing a data structure is found in said data base that corresponds to said constructed data structure.

20. The method according to claim 19, wherein said comparing is done according to a Nearest Neighbor Search method.

21. The method according to claim 19, wherein said comparing is done according to a Locality Sensitive Hashing search method.

22. The method according to claim 19, wherein said comparing is done according to a Product Quantization search method.

23. A device for obtaining a mega-frame image fingerprint from a temporal section of a video sequence, comprising:
a temporal section selector configured to select a temporal section of the video sequence, the temporal section being defined by boundary image frames in the video sequence, the boundary image frames delimiting a sequence of image frames;
a stable frame selector configured to select a maximum of k stable image frames j in the selected temporal section, by computing of a sum of similarity distances between a number of neighbor image frames of a candidate stable image frame j in the selected temporal section and determining the k minimum computed sums of similarity distances in the temporal section, while respecting a interspacing of at least n image frames between the stable image frames j;
a best frame selector configured to select, for each of the selected maximum k stable image frames j, an image frame within a selection window of a width of M frames, the selection window being centered in the selected stable image frame j, the selected image frame replacing the selected stable image frame j;
a data structure constructor configured to compute an image fingerprint for each of the selected maximum k stable image frames j, and configured to construct a mega-frame image fingerprint data structure that comprises the computed image fingerprints.

24. A device for identifying a video sequence, the device comprising:
a temporal section selector configured to select a temporal section of the video sequence defined by boundary image frames in the video sequence, said boundary image frames delimiting a sequence of image frames in the video sequence;
a stable frame selector configured to select a maximum of k stable image frames in the selected temporal section, by computing a sum of similarity distances between a number of neighbor image frames of a candidate stable image frame j in the selected temporal section and determining the k minimum computed sums of similarity distances in the temporal section, while respecting an interspacing of at least n image frames between the stable image frames;
a best frame selector configured to select, for each of the maximum k determined stable image frames, an image frame within a selection window of a width of M frames, the selection window being centered in the selected stable image frame j, the selected image frame replacing the selected stable image frame j;
a data structure constructor configured to compute an image fingerprint for each of the determined maximum k stable image frames j, and for constructing of a mega-frame image fingerprint data structure that comprises the computed image fingerprints;
a data structure comparator configured to compare the constructed mega-frame image fingerprint data structure with mega-frame image fingerprint data structures from an image fingerprint data base; and
said video sequence being identified by one of said data structures in said data base, if upon said comparing a data structure is found in said data base that corresponds to said constructed data structure.

25. The method according to claim 13, wherein said image frame selected in said step of selecting an image frame within a selection window is an I-frame with a luminous exposure that is within defined limits.

26. The method according to claim 19, wherein said image frame selected in said step of selecting an image frame within a selection window is an I-frame.

27. The method according to claim 19, wherein said image frame selected in said step of selecting an image frame within a selection window is an image frame with a luminous exposure that is within defined limits.

28. The method according to claim 19, wherein said image frame selected in said step of selecting an image frame within a selection window is an I-frame with a luminous exposure that is within defined limits.

29. The device according to claim 23, wherein said image frame selected by said best frame selector within said selection window is an I-frame.

30. The device according to claim 23, wherein said image frame selected by said best frame selector within said selection window is an image frame with a luminous exposure that is within defined limits.

31. The device according to claim 23, wherein said image frame selected by said best frame selector within said selection window is an I-frame with a luminous exposure that is within defined limits.

32. The device according to claim 24, wherein said image frame selected by said best frame selector within said selection window is an I-frame.

33. The device according to claim 24, wherein said image frame selected by said best frame selector within said selection window is an image frame with a luminous exposure that is within defined limits.

34. The device according to claim 24, wherein said image frame selected by said best frame selector within said selection window is an I-frame with a luminous exposure that is within defined limits.
